(19) United States
(12) Patent Application Publication
(10) Pub. No.: US 2018/0180257 A1
(43) Pub. Date: Jun. 28, 2018

(54) ILLUMINATION APPARATUS FOR ADJUSTING LIGHT DISPERSION AND BRIGHTNESS FOR AN ELECTRONIC DEVICE HAVING A LIGHT SOURCE

(71) Applicant: MARK & DRAW INC, SEOUL (KR)

(72) Inventor: Teakjin CHOI, Seoul (KR)

(21) Appl. No.: 15/388,811

(22) Filed: Dec. 22, 2016

(51) Int. Cl. F21V 14/06; F21V 17/10

(52) U.S. Cl. CPC F21V 14/065; F21V 17/10

(57) ABSTRACT

An illumination apparatus for controlling the brightness and dispersion of light from an electronic device having a light source includes a lens unit, a base assembly, a clamp, and a detachable lantern housing. The lens unit includes a lens, a side wall, and a handle. The lens unit is housed inside a hollow body portion of the base assembly. The base assembly further includes an arm. The arm includes a narrow aperture through which a rail of the clamp is fitted. The lantern housing includes a reflector, a casing, and a cap.

### FIELD OF THE INVENTION

The present invention relates to an illumination apparatus for adjusting light dispersion and brightness for an electronic device having a light source and, more particularly, to an attachable and detachable apparatus for converting an electronic device having a light source commonly used as a camera flash into a dual-functional flashlight and lantern with adjustable light emission. Light dispersion and brightness is controlled by sliding a handle to position a lens farther or closer to the light source of the electronic device. The illumination apparatus has an adjustable clamp, by which an electronic device of varying dimensions is secured. The electronic device may be a mobile phone, smartphone, tablet computing device, or the like.

### BACKGROUND OF THE INVENTION

Portable electronic devices, such as mobile phones, smartphones, tablet computers, and the like, have become ubiquitous for communication, entertainment, and other purposes. As their use as digital cameras has grown increasingly important to their function, the integration of a bright light source such as a light emitting diode (LED) for photographic flash into the design of portable electronic devices has become standard. A variety of software has been developed to use this light source for functions other than photographic flash. For example, the user of a smartphone may use the built in LED as a crude flashlight to see in the dark.

However, there is a need for an accessory optical apparatus to better utilize electronic devices having a light source. Ideally, the illumination apparatus would allow the user to easily adjust the brightness and dispersion of the emitted light. Furthermore, such an apparatus needs to be easily attachable and detachable to electronic devices having varying display sizes, thicknesses, and light source positions.

### SUMMARY OF THE INVENTION

The present invention is directed to an illumination apparatus for adjusting the dispersion and brightness of an electronic device having a light source for use as an adjustable flashlight or lantern. The apparatus includes a lens assembly, a base assembly that houses the lens assembly, and a clamp by which an electronic device may be adjustably attached. The position of the lens with respect to the light source, which determines both the dispersion and brightness of the emitted light, can be easily adjusted to the user's needs.

According to one embodiment of the present invention, the illumination apparatus for adjusting light dispersion and brightness may include: a lens unit having a lens; a base assembly having a vertical axis, wherein the lens unit is constructed to move, axially within the base assembly; and a clamp attached to the base assembly wherein the clamp may be constructed to be removably coupled to an electronic device having a light source.

Another embodiment of the present invention having a lens unit, a base assembly, and a clamp may provide for the illumination device's base assembly to further include: a hollow body having an upper rim and a lower rim, aligned about the vertical axis, and a hollow body wall, wherein the hollow body wall may have a vertical slit substantially parallel to the vertical axis, wherein the lens unit further may include a side wall surrounding an edge of the lens and a handle fixedly attached to the side wall, wherein the handle may be configured to move axially along the vertical slit so that the lens unit slides up and down the hollow body.

According to another embodiment, of the present invention having a lens unit, a base assembly, and a clamp, the vertical slit may further include a first slit and a second slit, wherein the first slit may be located opposite the vertical axis from the second slit. The handle may further include a first handle and a second handle, wherein the first handle may be located opposite the vertical axis from the second handle.

In another embodiment of the present invention having a lens unit, a base assembly, and a clamp, the hollow body of the base assembly may be substantially cylindrical.

Another embodiment of the present invention having a lens unit, a base assembly, and a clamp may provide for the illumination device's base assembly to further include: an arm fixedly attached to the hollow body wall, wherein the arm may contain a narrow aperture, wherein the clamp may further include a rail that fits through the aperture and may be adjustably fixed thereof

Another embodiment of the present invention having a lens unit, a base assembly, and a clamp may provide for the illumination device's base assembly to further include: a coupling pad constructed to attach by a frictional fit to a bottom opening of the base assembly, wherein the coupling pad may have a protrusion having a surface in frictional contact with the rail of the clamp, wherein the coupling pad may include a hole substantially coaxial with a lower rim of the base assembly; and a support pad constructed to fit in a space in the arm, wherein an end of the support pad may be in frictional contact with the side wall of the lens unit and a surface of the support pad may be in frictional contact with the rail of the clamp.

According to another embodiment of the present invention having a lens unit, a base assembly, and a clamp, the coupling pad and the support pad may be made of a soft material, wherein one or both of the surfaces in contact with the clamp rail may further include a plurality of bumps, wherein the rail of the clamp may further include a slot wherein each bump may be constructed to tightly fit and provide frictional resistance to unwanted movements of the base assembly.

According to another embodiment of the present invention having a lens unit, a base assembly, and a clamp, the lens may have a convex surface.

According to another embodiment of the present invention having a lens unit, a base assembly, and a clamp, the base assembly may further include a lower housing including a lower arm portion and a lower hollow body portion, and having a top side and a bottom side; and an upper housing including an upper arm portion and an upper hollow body portion, wherein the upper housing may be fixedly attached to the lower housing at the top side of the lower housing.

According to another embodiment of the present invention having a lens unit, a base assembly, and a clamp, the clamp may be formed into a “C” shape including a rail, an adjoining section, and a lower section, wherein the lower section may have an inner side and an outer side, wherein the inner side may be oriented in the direction of the rail and a pad is fixedly attached to the inner side of the lower section of the clamp, wherein the pad is made of a soft material.

According to another embodiment of the present invention having a lens unit, a base assembly, and a clamp, the clamp may include a rail having an adjoining end and an open end, wherein a bumper made of a soft material may be attached to the open end.

According to another embodiment of the present invention having a lens unit, a base assembly, and a clamp, the clamp may have an adjoining end with a cord attached by which the user may secure the illumination apparatus.

Another embodiment of the present invention may provide for an illumination apparatus for controlling light dispersion and brightness including: a lens unit having a lens; a base assembly having a vertical axis wherein the lens unit may be constructed to move axially within the base assembly; a clamp attached to the base assembly, wherein the clamp may be constructed to be removably coupled to an electronic device having a light source; and a lantern housing, which is removably attached to the base assembly.

According to another embodiment of the present invention having a lens unit, a base assembly, a clamp, and a lantern housing, the lantern housing may include: a casing having a base end and a cap end, wherein the casing may be removably attached at the base end to the base assembly at the upper rim of the hollow body; a reflector housed in the casing; and a cap attached to the casing at the cap end.

In another embodiment of the present invention having a lens unit, a base assembly, a clamp, and a lantern housing, the reflector may have a tapered end and the tapered end may be directed substantially toward the light source.

In another embodiment of the present invention having a lens unit, a base assembly, a clamp, and a lantern housing, the reflector may be in the shape of a right circular cone.

In another embodiment of the present invention having a lens unit, a base assembly, a clamp, and a lantern housing, the reflector may be in the shape of a right circular cone having an opening angle of about 30-75 degrees and is substantially coaxial with the casing.

In another embodiment of the present invention having a lens unit, a base assembly, a clamp, and a lantern housing, the reflector may be in the shape of a right circular cone having an opening angle of about 52 degrees and is substantially coaxial with the casing.

In another embodiment of the present invention having a lens unit, a base assembly, a clamp, and a lantern housing, the reflector may further include a circumferential ridge, by which the reflector is mounted at the cap end of the casing.

According to another embodiment of the present invention having a lens unit, a base assembly, a clamp, and a lantern housing, the reflector may have a surface including a plurality of circumferential steps.

According to another embodiment of the present invention having a lens unit, a base assembly, a clamp, and a lantern housing, the casing may further include: a main body; a cap connecting region; a base connecting region; and an o-ring surrounding the base connecting region, wherein the lantern housing may attach removably to the base assembly by a frictional contact between the o-ring and the upper rim of the base assembly. The cap connecting region and the base connecting regions of the casing may be smaller in outer circumference than the main body.

According to another embodiment of the present invention having a lens unit, a base assembly, a clamp, and a lantern housing, the casing of the lantern housing may be substantially cylindrical in shape and may further include a plurality of longitudinal bumps about a cylindrical axis.

According to one embodiment of the present invention, the illumination apparatus for adjusting light dispersion and brightness may include: a lens unit having a lens; a base assembly having a vertical axis, wherein the lens unit is constructed to move axially within the base assembly; and a clamp attached to the base assembly wherein the clamp may be constructed to be removably coupled to an electronic device having a light source.

Another embodiment of the present invention having a lens unit, a base assembly, and a clamp may provide for the illumination device's base assembly to further include: a hollow body having an upper rim and a lower rim, aligned about the vertical axis, and a hollow body wall, wherein the hollow body wall may have a vertical slit substantially parallel to the vertical axis, wherein the lens unit further may include a side wall surrounding an edge of the lens and a handle fixedly attached to the side wall, wherein the handle may be configured to move axially along the vertical slit so that the lens unit slides up and down the hollow body.

According to another embodiment of the present invention having a lens unit, a base assembly, and a clamp, the vertical slit may further include a first slit and a second slit, wherein the first slit may be located opposite the vertical axis from the second slit. The handle may further include a first handle and a second handle, wherein the first handle may be located opposite the vertical axis from the second handle.

In another embodiment of the present invention having a lens unit, a base assembly, and a clamp, the hollow body of the base assembly may be substantially cylindrical.

Another embodiment of the present invention having a lens unit, a base assembly, and a clamp may provide for the illumination device's base assembly to further include: an arm fixedly attached to the hollow body wall, wherein the arm may contain a narrow aperture, wherein the clamp may further include a rail that fits through the aperture and may be adjustably fixed thereof

Another embodiment of the present invention having a lens unit, a base assembly, and a clamp may provide for the illumination device's base assembly to further include: a coupling pad constructed to attach by a frictional fit to a bottom opening of the base assembly, wherein the coupling pad may have a protrusion having a surface in frictional contact with the rail of the clamp, wherein the coupling pad may include a hole substantially coaxial with a lower rim of the base assembly; and a support pad constructed to fit in a space in the arm, wherein an end of the support pad may be in frictional contact with the side wall of the lens unit and a surface of the support pad may be in frictional contact with the rail of the clamp.

According to another embodiment of the present invention having a lens unit, a base assembly, and a clamp, the coupling pad and the support pad may be made of a soft material, wherein one or both of the surfaces in contact with the clamp rail may further include a plurality of bumps, wherein the rail of the clamp may further include a slot wherein each bump may be constructed to tightly fit and provide frictional resistance to unwanted movements of the base assembly.

According to another embodiment of the present invention having a lens unit, a base assembly, and a clamp, the lens may have a convex surface.

According to another embodiment of the present invention having a lens unit, a base assembly, and a clamp, the base assembly may further include a lower housing including a lower arm portion and a lower hollow body portion, and having a top side and a bottom side; and an upper housing including an upper arm portion and an upper hollow body portion, wherein the upper housing may be fixedly attached to the lower housing at the top side of the lower housing.

According to another embodiment of the present invention having a lens unit, a base assembly, and a clamp, the clamp may be formed into a “C” shape including a rail, an adjoining section, and a lower section, wherein the lower section may have an inner side and an outer side, wherein the inner side may be oriented in the direction of the rail and a pad is fixedly attached to the inner side of the lower section of the clamp, wherein the pad is made of a soft material.

According to another embodiment of the present invention having a lens unit, a base assembly, and a clamp, the clamp may include a rail having an adjoining end and an open end, wherein a bumper made of a soft material may be attached to the open end.

According to another embodiment of the present invention having a lens unit, a base assembly, and a clamp, the clamp may have an adjoining end with a cord attached by which the user may secure the illumination apparatus.

According to another embodiment of the present invention, the soft material used to form various pads and frictional surfaces may be silicone, natural rubber, thermoplastic polyurethane, or another elastomeric polymer, but not limited.

The advantages of the present invention include: (1) the illumination apparatus converts an electronic device having a light source into an adjustable flashlight or portable adjustable lantern; (2) as a flashlight, the dispersion and brightness of the light from the electronic device can be easily adjusted by a slidable handle; (3) as a lantern, the brightness of the light from the electronic device can be easily adjusted by a slidable handle; (4) the position of the base assembly on the clamp is adjustable and thus the illumination apparatus can be coupled to an electronic device of varying dimensions; (5) the surfaces of the illumination apparatus in contact with the electronic device are made of a soft material so the electronic device can be securely fastened to the illumination apparatus without risk of scratching or otherwise damaging the electronic device.

Although the present invention is briefly summarized, a fuller understanding of the invention can be obtained by the following drawings, detailed description and appended claims.

### BRIEF DESCRIPTION OF THE DRAWINGS

These and other features, aspects, and advantages of the present invention will become better understood with reference to the accompanying drawings, wherein:

FIG. 1 shows a perspective view of the illumination apparatus in accordance with the present invention with the lantern housing removed;

FIG. 2 shows a perspective view of the present invention with the lantern housing attached;

FIG. 3 shows a perspective view of the base assembly portion of the present invention;

FIG. 4 shows a top plan view of the illumination apparatus of the present invention;

FIG. 5 shows a bottom plan view of the illumination apparatus of the present invention;

FIG. 6 shows a side view of the base assembly of the present invention with the clamp removed for clarity and the lens unit positioned close to the upper rim.

FIG. 7 shows a cross-sectional view of the base assembly as taken through the plane indicated by line “7&9” in FIG. 4 with the clamp removed for clarity and the lens unit positioned close to the upper rim.

FIG. 8 shows a side view of the base assembly of the present invention with the clamp removed for clarity and the lens unit positioned close to the lower rim.

FIG. 9 shows a cross-sectional view of the present invention as taken through the plane indicated by line “7&9” in FIG. 4 with the clamp removed for clarity and the lens unit positioned close to the lower rim.

FIG. 10 shows an exploded view of various elements of the lantern housing of the present invention.

FIG. 11 shows a cross-sectional view of the casing of the lantern housing of the present invention as taken through the plane indicated by line “11” of FIG. 10.

FIG. 12 shows a perspective view of the clamp and the arm of the base assembly of the present invention.

FIG. 13 shows a perspective view of the coupling pad.

FIG. 14 shows an exploded view of an embodiment of the present invention.

### DETAILED DESCRIPTION OF THE EMBODIMENTS OF THE INVENTION

Reference will now be made in detail to the preferred embodiments of the present invention, examples of which are illustrated in the accompanying drawings, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention.

Also, as used in the specification including the appended claims, the singular forms “a”, “an”, and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations by use of the word “about”, it will be understood that the particular value forms another embodiment.

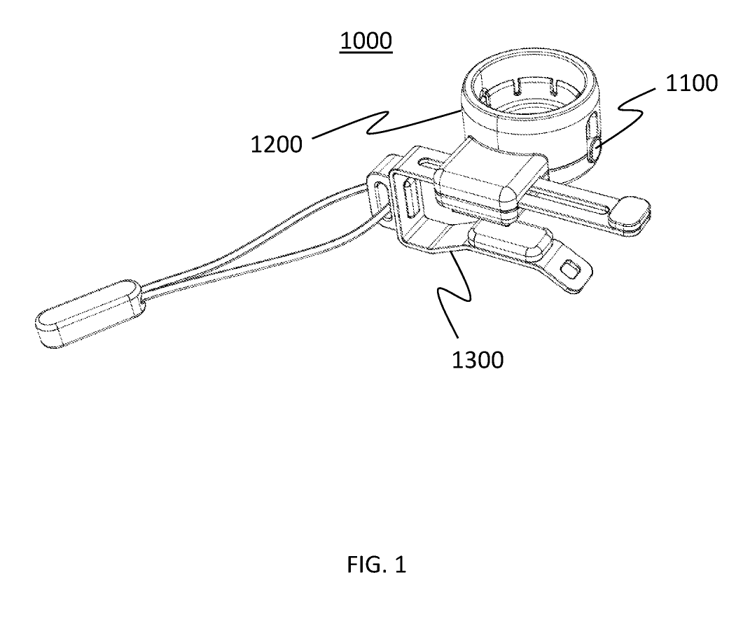

FIG. 1 is a perspective view of an illumination apparatus 1000 for adjusting light dispersion and brightness of an electronic device having a light source of the present invention. As shown in FIG. 1, the illumination apparatus 1000 may include a lens unit 1100, a base assembly 1200, wherein the lens unit 1100 is housed, and a clamp 1300 by which an electronic device may be removably attached to the illumination apparatus 1000.

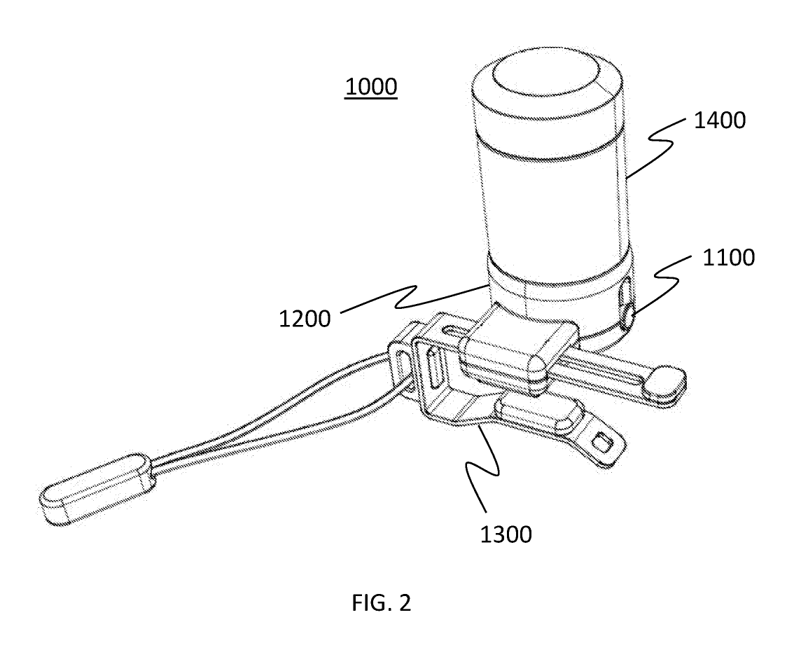

FIG. 2 is a perspective view of another embodiment of the illumination apparatus 1000 for adjusting light dispersion and brightness of an electronic device having a light source. As shown in FIG. 2, the illumination apparatus 1000 of FIG. 1 may further include a lantern housing 1400. The lantern housing 1400 may easily and securely be attached to the base assembly by a frictional fit according to a user's needs.

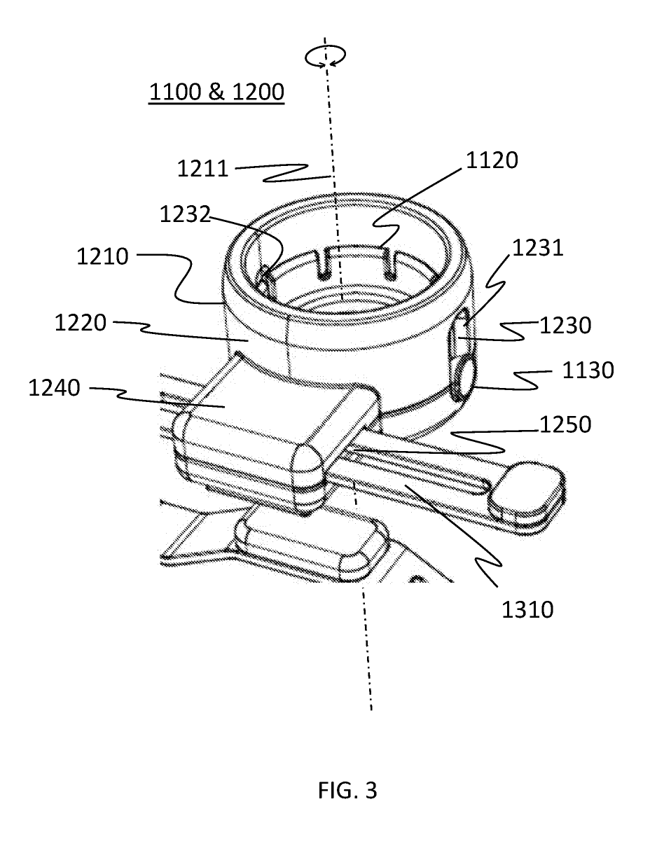

As shown in the perspective view of the base assembly 1200 in FIG. 3, the base assembly 1200 may include: a hollow body 1210 having a vertical axis 1211 and further including a hollow body wall 1220 and a vertical slit 1230 substantially parallel to the vertical axis 1211 in the hollow body wall 1220; and an arm 1240 fixedly attached to the hollow body wall 1220. The lens unit 1100 may include a side wall 1120 and a handle 1130 fixedly attached to the side wall 1120. The handle 1130 may be accessible through the vertical slit 1230, allowing the user to slide the lens unit 1100 up and down the vertical axis 1211. The arm 1240 may further include a narrow aperture 1250, wherein a rail 1310 of the clamp 1300 may be adjustably attached. The adjustable feature of the clamp 1300 and the base assembly 1200 attachment may allow the illumination apparatus 1000 to be coupled to an electronic device having varying dimensions such as length, width, and thickness and having a light source in different positions on the electronic device. The vertical slit 1230 may include a first slit 1231 and a second slit 1232.

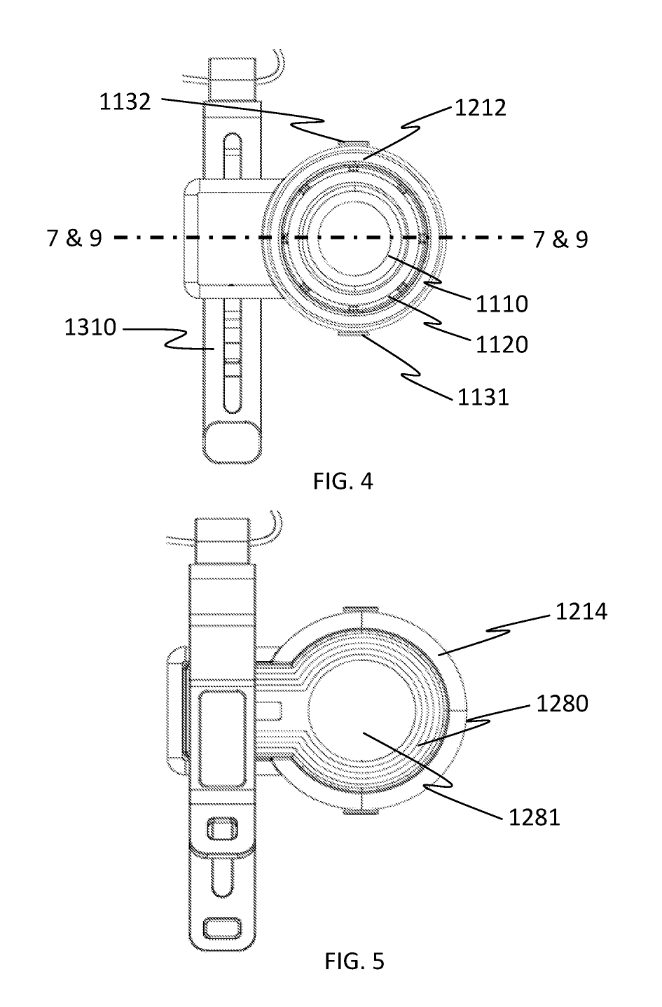

FIG. 4 is a top plan view of an embodiment of the illumination apparatus 1000 with the lantern housing 1400 removed. The hollow body 1210 of the base assembly 1200 may include an upper rim 1212. The lens unit 1100 may include a lens 1110, the side wall 1120 surrounding an edge 1116 of the lens 1110. The handle 1130 shown in FIG. 3 may further include a first handle 1131 and a second handle 1132 opposite the first handle 1131; the two handles may be accessible to the user to adjust the brightness and dispersion of emitted light. The design of two oppositely positioned handles 1131 and 1132 may provide extra stability to the axial movement of the lens unit 1100. Also shown in FIG. 4 is the rail 1310 of the clamp 1300. The base assembly 1200 may move longitudinally along the rail 1310 to allow the user to position the base assembly 1200 to his needs according to the size of the electronic device with a light source.

FIG. 5 shows a bottom plan view of an embodiment of the illumination apparatus 1000. The hollow body 1210 of the base assembly 1200 may have a lower rim 1214. The base assembly 1200 may further include a coupling pad 1280. The coupling pad may have a hole 1281 substantially coaxial with the lower rim 1214 of the hollow body 1210. The coupling pad 1280 may be made of a soft material. The soft material may be selected from a silicone, natural rubber, thermoplastic polyurethane, or another elastomeric polymer, but not limited. The soft material may allow for attachment of the illumination apparatus 1000 to the electronic device having a light source to not scratch or otherwise damage a contacting surface of the electronic device. Additionally, the frictional contact between illumination apparatus 1000 and the electronic device provided by the soft material may prevent the electronic device from slipping or being unintentionally misaligned while in use.

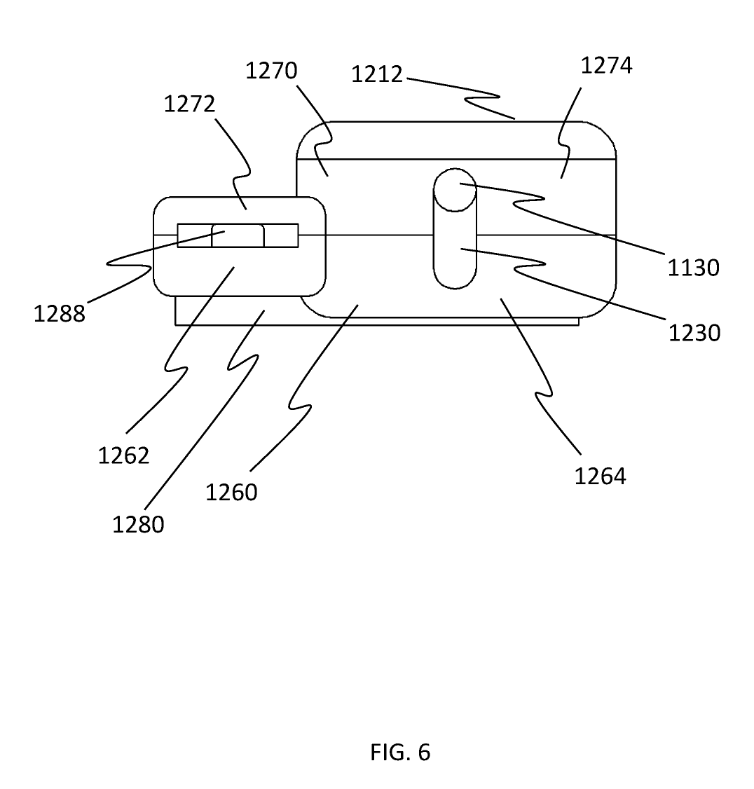

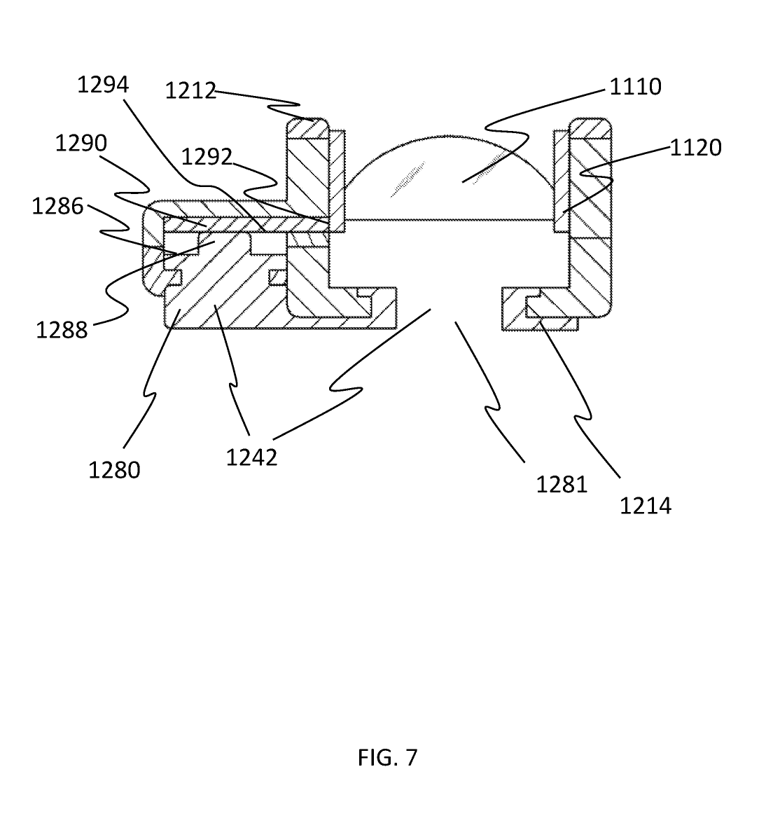

FIGS. 6-10 depict view of the illumination apparatus 1000 with the clamp 1400 detached for clarity of the illustrations. FIG. 6 is a side view of the illumination apparatus 1000. FIG. 7 is a cross-sectional view along line “7&9” in FIG. 4 from the same side as FIG. 6. The hollow body 1210 and the arm 1240 of the base assembly 1200 may further include: a lower housing 1260 including a lower arm portion 1262 and a lower hollow body portion 1264, and having a top side 1266 and a bottom side 1268; and an upper housing 1270 including an upper arm portion 1272 and an upper hollow body portion 1274, wherein the upper housing 1270 is fixedly attached to the lower housing 1260 at the top side 1266 of the lower housing 1260.

The coupling pad 1280 may be constructed to attach by a frictional fit through a bottom opening 1242 of the base assembly 1200, wherein the coupling pad 1280 may have a protrusion 1282 having a surface 1286 in frictional contact with the rail 1310 of the clamp 1300, wherein the coupling pad 1280 may include a hole 1281 substantially coaxial with a lower rim 1214 of the base assembly 1200. The base assembly may further include a support pad 1290. The coupling pad 1280 and support pad 1290 may be made of a soft material such as silicone, natural rubber, thermoplastic polyurethane, or the like. In FIG. 6, the handle 1130 of the lens unit 1100 is shown in a position along the vertical slit 1230 close to the upper rim 1212 of the hollow body 1210 of the base assembly 1200. Likewise, FIG. 7 depicts the lens unit 1100 including the lens 1110 and side wall 1120 positioned close to the upper rim 1212.

As seen in FIG. 7, the support pad 1290 may provide frictional contact to be made at an edge 1292 with the side wall 1120 of the lens unit 1100. Additionally the support pad 1290 may provide frictional contact to be made at a surface 1294 with the clamp 1300 (not shown). In this way, the support pad 1290 may provide additional stability and resistance to unwanted slipping of both the lens unit 1100 and the clamp 1300. The coupling pad 1280 may include a surface 1286 on the first protrusion 1282; this surface 1286 may provide frictional contact with the clamp 1300. FIGS. 6 and 7 also depict in profile view the surface 1286 on the first protrusion 1282 having a plurality of bumps 1288. The bumps 1288 may be constructed to tightly fit in a slot 1312 in the rail 1310 of the clamp 1300. While the plurality of bumps 1288 is depicted as being on the surface 1286 of the first protrusion 1282, the bumps 1288 may also be included on surface 1294 of the support pad 1290, both surfaces 1286 and 1294, or neither.

As shown in FIG. 7, the lens 1110 may be convex.

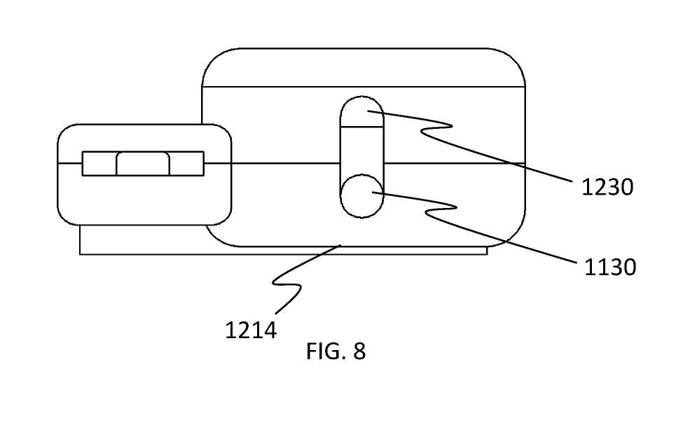

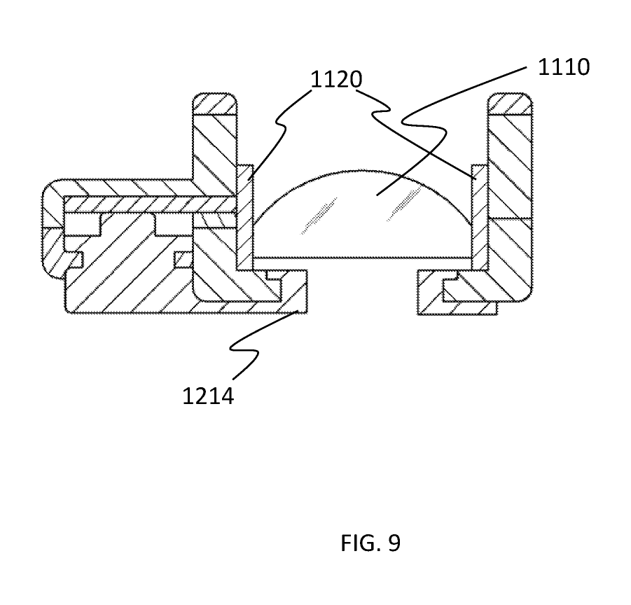

When the lens unit 1100 is positioned closest to the upper rim 1212 as shown in FIGS. 6 and 7, the brightness and narrowness of the light emitted from the illumination apparatus 1000 may both be maximized. FIGS. 8 and 9 show a side view and a cross-sectional view through line “7&9”, respectively, of the illumination apparatus when the lens unit 1100 and the attached handle 1130 are positioned closest to the lower rim 1214. In the configuration of FIGS. 8 and 9, the dispersion of emitted light is broadest and the brightness is minimized. The lens unit 1100 may be positioned in the two positions described and shown or anywhere in between. In this way, the user can easily adjust the light from his electronic device having a light source to his needs by simply sliding the handle 1130 along the vertical slit 1230.

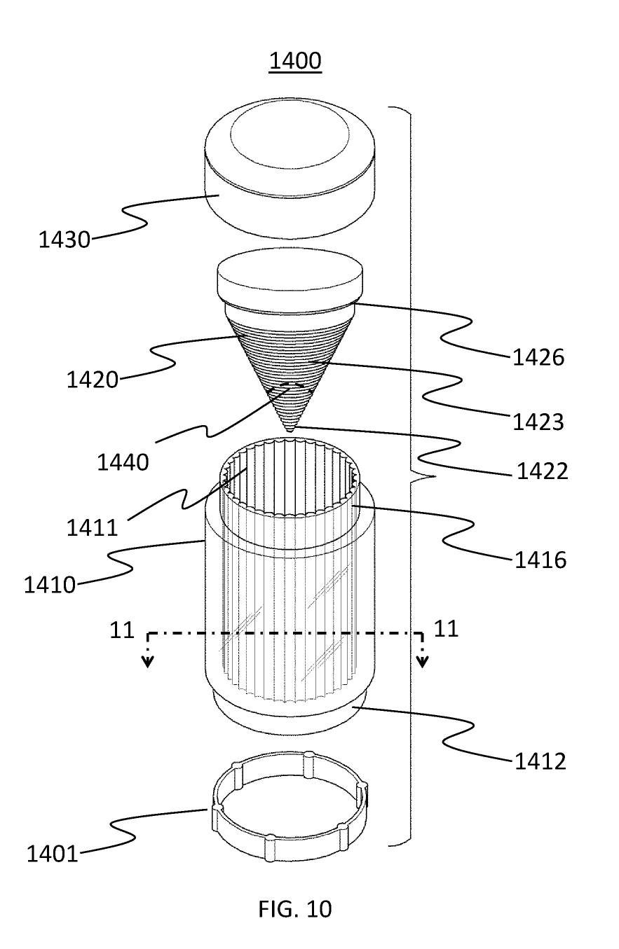

FIG. 10 shows an exploded view of the lantern housing 1400. The lantern housing 1400 may be removably attached to the base assembly 1200 such that the illumination apparatus may convert the electronic device having a light source into a portable lantern that may be held by the user or set on a surface. The lantern housing 1400 may include a casing 1410, reflector 1420, and a cap 1430. The casing 1410 may further include a base end 1412 and a cap end 1416, wherein the base end 1412 may be removably attached to the base assembly 1200 at the the upper rim 1212. The base end 1412 may be substantially surrounded by an o-ring 1401. The reflector 1420 may be oriented in the direction of the light source. The reflector 1420 may further include a circumferential ridge 1426, by which the reflector 1420 may be mounted at the cap end 1416 of the casing 1410. The reflector 1420 may have a surface including a plurality of circumferential steps 1423. The reflector 1420 may have a tapered end 1422 and the tapered end 1422 may be directed substantially toward the lens 1110. Furthermore, the reflector 1420 may be in the shape of a right circular cone. The reflector 1420 in the shape of a right circular cone may have an opening angle 1440 of about 30-75 degrees and may be substantially coaxial with the casing 1410. The shape of the reflector 1420 and the surface including a plurality of circumferential steps 1423 may be designed to efficiently reflect and shine light out of the transparent casing 1410. The distance of the reflector 1420 to the lens unit 1100 may be critical to the brightness and dispersion of light from the casing 1410. Thus, light emission from the illumination apparatus 1000 with the lantern housing 1400 may be adjusted by simply sliding the handle 1130 along the vertical slit 1230. An o-ring 1401 may be attached to the casing 1410 at the base end 1412.

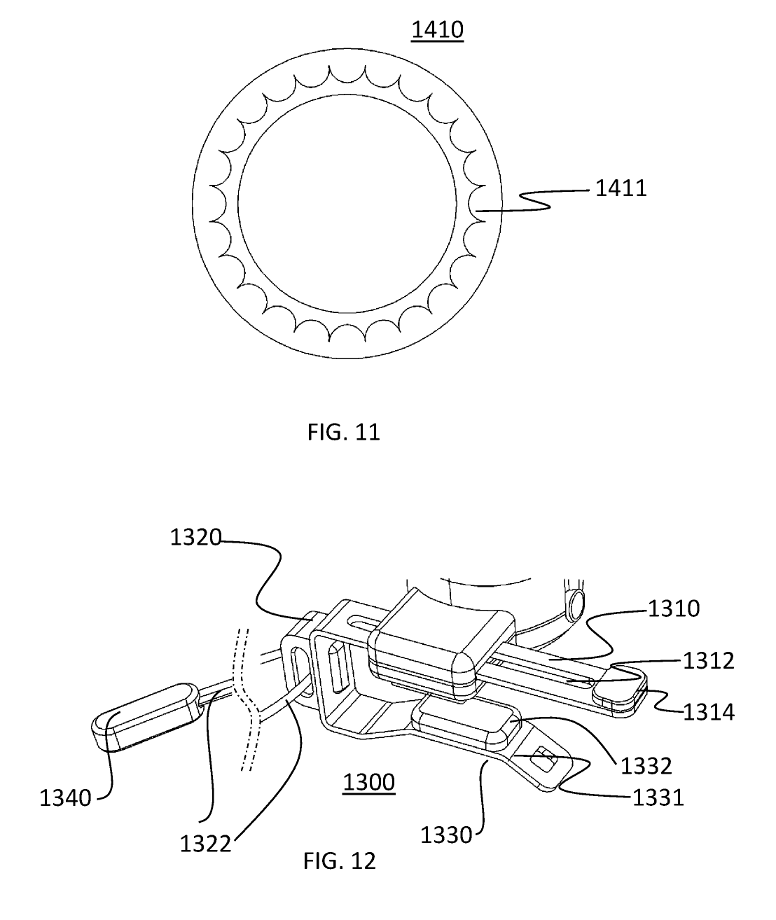

As shown in FIGS. 10 and 11, the casing 1410 may be substantially cylindrical in shape having a cylindrical axis and may further include a plurality of longitudinal bumps 1411 about the cylindrical axis. A cross sectional view through the plane indicated by line “11” in FIG. 10 is shown in FIG. 11 to illustrate the internal surface of the casing in this embodiment. The casing 1410 may be so constructed to efficiently scatter light.

FIG. 12 shows a perspective view of the clamp 1300 of the illumination apparatus 1000. The clamp 1300 may have a “C” shape including the rail 1310, an adjoining section 1320, and a lower section 1330, wherein the lower section may have an inner side 1331, wherein the inner side 1331 may be oriented in the direction of the rail 1310 and a clamp pad 1332 is fixedly attached to the inner side of the lower section 1330 of the clamp 1300, wherein the clamp pad 1332 is made of a soft material. FIG. 11 also depicts a slot 1312 of the rail 1310, wherein the protrusion of bumps 1288 may fit through the slot 1332. The rail 1310 may include a bumper 1314 made of a soft material attached at an end. The adjoining section may include a cord 1322 attached to the adjoining section 1320 by which the user may secure the illumination apparatus 1000. The cord may further include a grip 1340. The cord 1322 and the grip 1340 may add convenience when carrying the illumination apparatus 1000.

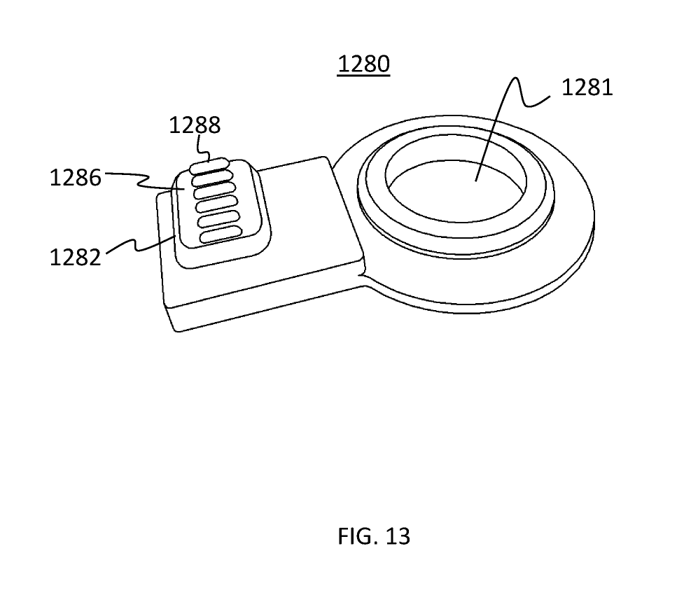

FIG. 13 is a perspective view of the coupling pad 1280 by itself. The coupling pad 1280 may include a protrusion 1282 having a surface 1286. The surface 1286 may further include a plurality of bumps 1288. The coupling pad 1280 may be made of a soft material and be fitted to the base assembly 1200 by frictional fit through a bottom opening 1242. The plurality of bumps 1288 may fit through the slot 1332 of the rail 1310 shown in FIG. 12. The coupling pad 1280 may further include a hole 1281. Light from the electronic device having a light source may enter the illumination apparatus 1000 through the hole 1281

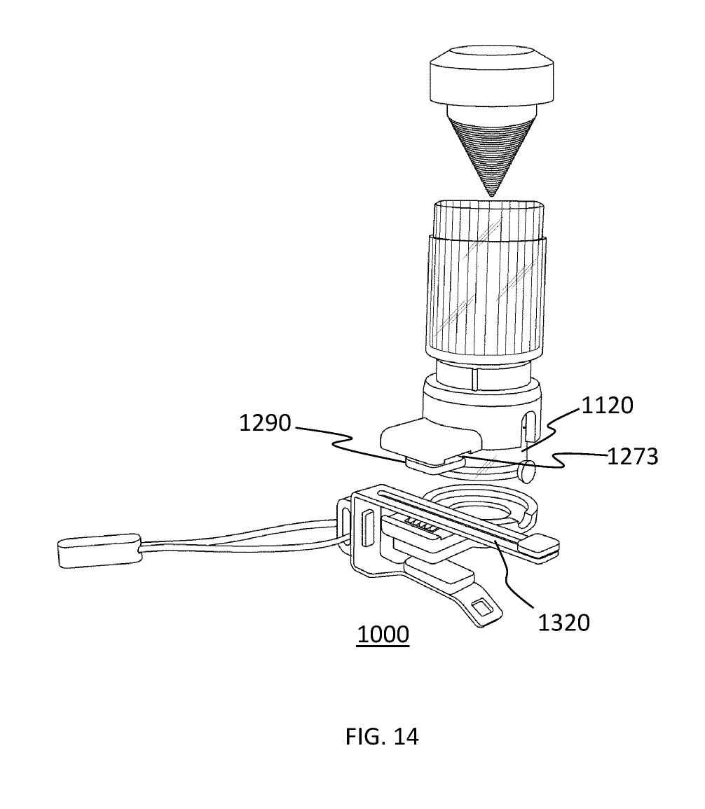

FIG. 14 is an exploded view of the illumination apparatus 1000 illustrating how the apparatus 1000 may be constructed and assembled. The support pad 1290 shown in the cross-sectional view FIG. 9 may be constructed to fit in a space 1273 in the base assembly 1200. The support pad 1290 may provide frictional contact to the side wall 1120 of the lens unit 1100 and the rail 1320 of the clamp 1300

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. An illumination apparatus (1000) for adjusting light dispersion and brightness comprising:
a lens unit (1100) having a lens (1110);
a base assembly (1200) having a vertical axis (1211), wherein the lens unit (1100) is constructed to move axially within the base assembly (1200); and
a clamp (1300) attached to the base assembly (1200), wherein the clamp (1300) is constructed to be removably coupled to an electronic device having a light source.

2. The illumination apparatus (1000) of claim 1, wherein the base assembly (1200) further comprises a hollow body (1210) having an upper rim (1212) and a lower rim (1214) aligned about the vertical axis (1211) and a hollow body wall (1220),
wherein the hollow body wall (1220) has a vertical slit (1230) substantially parallel to the vertical axis (1211),
wherein the lens unit (1100) further comprises a side wall (1120) of the lens (1110) and a handle (1130) fixedly attached to the side wall (1120),
wherein the handle (1130) is configured to move axially along the vertical slit (1230) so that the lens (1110) of the lens unit (1100) slides up and down the hollow body (1210).

3. The illumination apparatus (1000) of claim 2, wherein the vertical slit (1230) further comprises a first slit (1231) and a second slit (1232), wherein the first slit (1231) is located opposite the vertical axis (1211) from the second slit (1232),
and the handle (1130) further comprises a first handle (1131) and a second handle (1132), wherein the first handle (1131) is located opposite the vertical axis (1211) from the second handle (1132).

4. The illumination apparatus (1000) of claim 2, wherein the hollow body (1210) of the base assembly (1200) is substantially cylindrical.

5. The illumination apparatus (1000) of claim 1, wherein the base assembly (1200) further comprises:
an arm (1240) fixedly attached to the hollow body wall (1220), wherein the arm (1240) has an aperture (1250), wherein the clamp (1300) further comprises a rail (1310) that fits through the aperture (1250) and is adjustably fixed thereof.

6. The illumination apparatus (1000) of claim 1, wherein the base assembly (1200) further comprises:
a coupling pad (1280) constructed to attach by a frictional fit to a bottom opening (1242) of the base assembly (1200), wherein the coupling pad (1280) has a protrusion (1282) having a surface (1286) in frictional contact with the rail (1310) of the clamp (1300), wherein the coupling pad (1280) includes a hole (1281) substantially coaxial with a lower rim (1214) of the base assembly (1200) and
a support pad (1290) constructed to fit in a space (1273) in the arm (1240), wherein an end (1292) of the support pad (1290) is in frictional contact with the side wall (1120) of the lens unit (1100) and a surface (1294) of the support pad (1290) is in frictional contact with the rail (1310) of the clamp (1300).

7. The illumination apparatus (1000) of claim 6, wherein the coupling pad (1280) and the support pad (1290) are made of a soft material, wherein one or both of the surfaces (1294 and 1286) in contact with the clamp rail (1310) further comprise a plurality of bumps (1288), wherein the rail (1310) of the clamp (1300) further comprises a slot (1312) wherein each bump (1288) is constructed to tightly fit in the slot (1312).

8. The illumination apparatus (1000) of claim 1, wherein the lens (1110) is convex.

9. An illumination apparatus (1000) for adjusting light dispersion and brightness comprising:
a lens assembly (1100);
a base assembly (1200) wherein the lens assembly (1100) is housed;
a clamp (1300) attached to the base assembly (1200), wherein the clamp (1300) is constructed to be removably coupled to an electronic device having a light source; and
a lantern housing (1400) removably attached to the base assembly (1200).

10. The illumination apparatus (1000) of claim 9, wherein the lantern housing (1400) comprises:
a casing (1410) having a base end (1412) and a cap end (1416), wherein the casing (1410) is removably attached at the base end (1412) to the base assembly (1200);
a reflector (1420) housed in the casing (1410); and
a cap (1430) attached to the casing (1410) at the cap end (1416).

11. The illumination apparatus (1000) of claim 10, wherein the reflector (1420) has a tapered end (1422) and the tapered end (1422) is directed substantially toward lens (1110).

12. The illumination apparatus (1000) of claim 10, wherein the reflector (1420) is substantially in the shape of a right circular cone and is substantially coaxial with the casing (1410).

13. The illumination apparatus (1000) of claim 10, wherein the reflector (1420) further comprises a surface comprising a plurality of circumferential steps (1423).

14. The illumination apparatus (1000) of claim 10, wherein the casing (1410) of the lantern housing (1400) is substantially cylindrical and further comprises a plurality of longitudinal bumps (1411) about a cylindrical axis.

15. The illumination apparatus (1000) of claim 9, wherein the base assembly (1200) further comprises a hollow body (1210) having an upper rim (1212) and a lower rim (1214) aligned about the vertical axis (1211) and a hollow body wall (1220),
wherein the hollow body wall (1220) has a vertical slit (1230) substantially parallel to the vertical, axis (1211),
wherein the lens unit (1100) further comprises a side wall (1120) of the lens (1110) and a handle (1130) fixedly attached to the side wall (1120),
wherein the handle (1130) is configured to move axially along the vertical slit (1230) so that the lens (1110) of the lens unit (1100) slides up and down the hollow body (1210),
wherein the base end (1412) of the casing (1410) is removably attached at the base end (1412) to the hollow body (1410) at the upper rim (1212).

16. The illumination apparatus (1000) of claim 15, wherein the vertical slit (1230) further comprises a first slit (1231) and a second slit (1232), wherein the first slit (1231) is located opposite the vertical axis (1211) from the second slit (1232) and the handle (1130) further comprises a first handle (1131) and a second handle (1132), wherein the first handle (1131) is located opposite the vertical axis (1211) from the second handle (1132).

17. The illumination apparatus (1000) of claim 9, wherein the base assembly (1200) further comprises an arm (1240) fixedly attached to the hollow body wall (1220), wherein the arm (1240) has a aperture (1250), wherein the clamp (1300) further comprises a rail (1310) that fits through the aperture (1250) and is adjustably fixed thereof.

18. The illumination apparatus (1000) of claim 9, wherein the base assembly (1200) further comprises:
a coupling pad (1280) constructed to attach by a frictional fit to a bottom opening (1242) of the base assembly (1200), wherein the coupling pad (1280) has a protrusion (1282) having a surface (1286) in frictional contact with the rail (1310) of the clamp (1300), wherein the coupling pad (1280) includes a hole substantially coaxial with a lower rim (1214) of the base assembly (1200);
a support pad (1290) constructed to fit in a space (1273) in the arm (1240), wherein an end (1292) of the support pad (1290) is in frictional contact with the side wall (1120) of the lens unit (1100) and a surface (1294) of the support pad (1290) is in frictional contact with the rail (1310) of the clamp (1300).

19. The illumination apparatus (1000) of claim 18, wherein the coupling pad (1280) and the support pad (1290) are made of a soft material, wherein one or both of the surfaces (1294 and 1286) in contact with the clamp rail (1310) further comprise a plurality of bumps (1288), wherein the rail (1310) of the clamp (1300) further comprises a slot (1312) wherein each bump (1288) is constructed to tightly fit in the slot (1312).

20. The illumination apparatus (1000) of claim 9, wherein the lens (1110) is convex.
